(19) United States
(12) Patent Application Publication
(10) Pub. No.: US 2015/0344359 A1
(43) Pub. Date: Dec. 3, 2015

(54) SOLUTION OF POLYAMIDE FOR SENSOR ELEMENT

(71) Applicants: SUMITOMO BAKELITE COMPANY LIMITED, Shinagawa-ku (JP); AKRON POLYMER SYSTEMS, INC., Akron, OH (US)

(72) Inventors: Ritsuya KAWASAKI, Kobe-shi (JP); Takehiko MAETANI, Kawasaki-shi (JP); Toshihiko KATAYAMA, Nishinomiya-shi (JP); Jun OKADA, Kobe-shi (JP); Hideo UMEDA, Kobe-shi (JP); Limin SUN, Copley, OH (US); Jiaokai JING, Uniontown, OH (US); Dong ZHANG, Uniontown, OH (US); Frank W. HARRIS, Boca Raton, FL (US)

(73) Assignees: SUMITOMO BAKELITE COMPANY LIMITED, Shinagawa-ku (JP); AKRON POLYMER SYSTEMS, INC., Akron, OH (US)

(21) Appl. No.: 14/724,299

(22) Filed: May 28, 2015

Related U.S. Application Data
(60) Provisional application No. 62/004,977, filed on May 30, 2014.
(60) Provisional application No. 62/061,818, filed on Oct. 9, 2014.

(51) Int. Cl. C03C 17/32; G01D 5/00

(52) U.S. Cl. CPC C03C 17/32; G01D 5/00

(57) ABSTRACT

This disclosure, viewed from one aspect, relates to a method for producing a sensor element, including the following steps (A) and (B):
(A) applying a polyamide solution onto a base to form a polyamide film on the base; and
(B) forming a sensor element on the surface of the polyamide film,
wherein the base or the surface of the base is composed of glass or silicon wafer,
wherein a polyamide of the polyamide solution has a constitutional unit represented by the following general formulae (I) and (II):

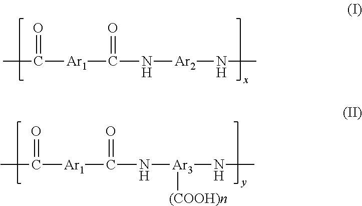

### CROSS REFERENCE TO RELATED APPLICATIONS

The disclosure is based upon and claims the benefits of priority under 35 U.S.C. 119 of U.S. Provisional Application Ser. No. 62/004,977, filed on May 30, 2014, and Ser. No. 62/061,818, filed on Oct. 9, 2014, the disclosures of which are hereby incorporated by reference herein in its entirety.

### TECHNICAL FIELD

The present disclosure, in one aspect, relates to a polyamide solution for producing a sensor element. The present disclosure, in another aspect, relates to a method for producing a sensor element using the polyamide solution.

### BACKGROUND ART

Glass plates, inorganic substrates such as YSZ, resin substrates, and composite material of these are used as substrates of sensor elements used in input devices such as image pickup devices (JP 2014-3244A). Such substrates of sensor elements are required to have transparency when arranged on the side of a light receiving portion.

For example, polycarbonates, which have high transparency, are known as transparent resins for use in optical applications. However, their heat resistance and mechanical strength can be an issue when used in production of display elements. Meanwhile, polyimides, for example, are known as heat resistant resins. However, typical polyimides are brown-colored, and hence can be an issue for use in optical applications. As polyimides with transparency, those having an alicyclic ring structure are known. However, such polyimides are poor in heat resistance.

WO 2012/129422 discloses a transparent polyamide film with thermal stability and dimensional stability. This transparent film is produced by casting an aromatic polyamide solution and curing the solution at a high temperature. The document discloses that the cured film has a transmittance of more than 80% over a range of 400 to 750 nm, a coefficient of thermal expansion (CTE) of less than 20 ppm/° C., and shows favorable solvent resistance. Further, the document discloses that the film can be used as a flexible substrate for a microelectronic device.

### SUMMARY

The present disclosure, in one or a plurality of embodiments, relates to a method for producing a sensor element, including the following steps (A) and (B):

(A) applying a polyamide solution onto a base to form a polyamide film on the base; and

(B) forming a sensor element of on the surface of the polyamide film,

wherein the base or the surface of the base is composed of glass or silicon wafer,

wherein a polyamide of the polyamide solution has a constitutional unit represented by the following general formulae (I) and (II):

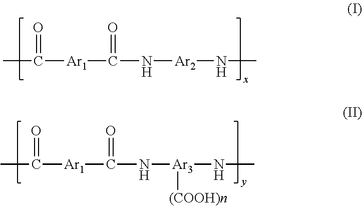

wherein x represents mol % of the constitutional unit of formula (I), y represents mol % of the constitutional unit of formula (II), x is 70 to 100 mol %, y is 0 to 30 mol %, and n is 1 to 4,

wherein Ar₁ is selected from the group comprising:

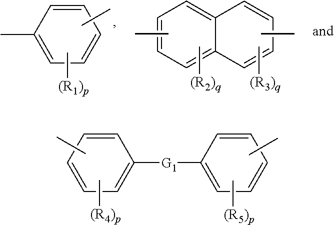

wherein in the formula above, p=4, q=3, wherein R₁, R₂, R₃, R₄ and R₅ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,

wherein G₁ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,

wherein Ar₂ is selected from the group comprising:

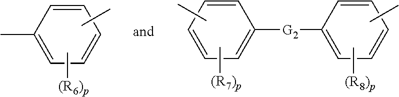

wherein in the formula above, p=4,

wherein R₆, R₇ and R₈ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,

wherein G₂ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,

wherein Ar₃ is selected from the group comprising:

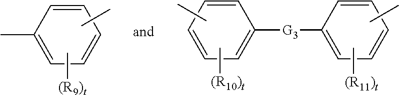

wherein in the formula above, t=0 to 3,

wherein R₉, R₁₀ and R₁₁ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof, and

wherein G₃ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group.

Further, in one or a plurality of embodiments, the present disclosure relates to a sensor element that includes a polyamide film produced by using the production method according to the present disclosure and formed from the polyamide solution according to the present disclosure.

### BRIEF DESCRIPTION OF THE DRAWINGS

FIG. 1 is a flow chart illustrating a method for producing a sensor element according to one embodiment.

FIG. 2 is a schematic cross-sectional view showing a sensor element 10 according to one embodiment.

### DETAILED DESCRIPTION

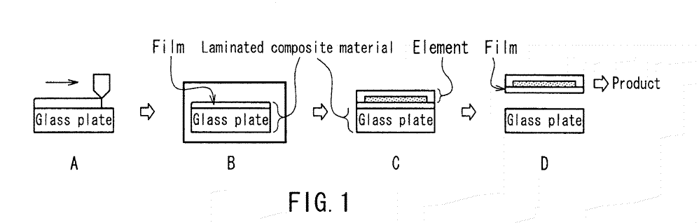

A sensor element used in an input device such as an image pickup device is often produced by a process shown in FIG. 1. Specifically, a polymer solution (varnish) is applied onto a base (glass or silicon wafer) (step a), the applied polymer solution is cured to form a film (step b), a sensor element is formed on the film (step c), and then the sensor element (product) is de-bonded from the base (step d).

In the production method of the sensor element shown in FIG. 1, a problem has been found that warpage deformation of a laminated composite material that includes the glass plate and the film obtained in the step b lowers the quality and yield. Specifically, the following problems have been found when warpage deformation appears in the laminated composite material: 1) transfer in the production process becomes difficult; 2) the exposure intensity changes in the patterning production, which makes it difficult to produce a uniform pattern; and/or 3) cracks are formed easily when an inorganic barrier layer is laminated. To cope with these problems, it has been found that a polyamide film that satisfies predetermined conditions can greatly suppress such warpage deformation of the laminated composite material. In other words, the present disclosure provides a polymer solution suitable for producing a sensor element used in an input device such as an image pickup device, i.e., a polymer solution suitable as a polymer solution (varnish) of the step a in FIG. 1.

Specifically, the present disclosure, in one embodiment, relates to a method for producing a sensor element (hereinafter, also referred to as a “production method according to the present disclosure”), including the following steps (A) and (B):

(A) applying a polyamide solution onto a base to form a polyamide film on the base; and

(B) forming a sensor element on the surface of the polyamide film,

wherein the base or the surface of the base is composed of glass or silicon wafer,

wherein a polyamide of the polyamide solution has a constitutional unit represented by the following general formulae (I) and (II):

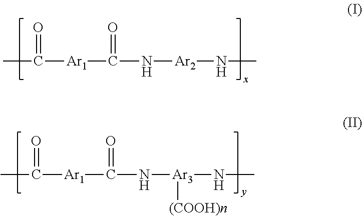

wherein x represents mol % of the constitutional unit of formula (I), y represents mol % of the constitutional unit of formula (II), x is 70 to 100 mol %, y is 0 to 30 mol %, and n is 1 to 4,

wherein Ar₁ is selected from the group comprising:

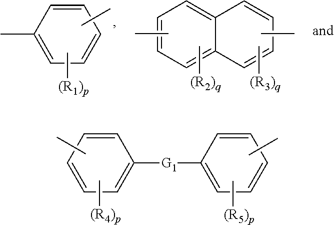

wherein in the formula above, p=4, q=3,

wherein R₁, R₂, R₃, R₄ and R₅ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,

wherein G₁ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,

wherein Ar₂ is selected from the group comprising:

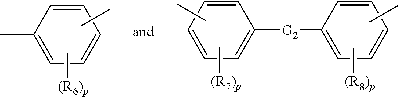

wherein in the formula above, p=4,

wherein R₆, R₇ and R₈ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,

wherein G₂ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,

wherein Ar₃ is selected from the group comprising:

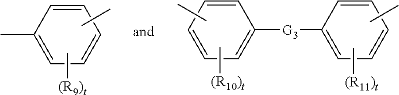

wherein in the formula above, t=0 to 3,

wherein R₉, R₁₀ and R₁₁ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof, and

wherein G₃ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group.

According to the production method according to the present disclosure, in one or a plurality of embodiments, the warpage deformation of the laminated composite material can be suppressed, thereby providing an effect of improving the quality and yield.

In one or a plurality of non-limiting embodiments, examples of the “sensor element” produced by the production method according to the present disclosure include a sensor element having a polyamide film form from a polyamide solution used in the production method of the present disclosure. In one or a plurality of embodiments, examples of a “sensor element” produced by the production method according to the present disclosure include a sensor element that is formed on the surface of the polyamide film formed on a base. In one or a plurality of embodiments, the sensor element can be de-bonded from the base. In one or a plurality of non-limiting embodiments, examples of the “sensor element” include a sensor element for electromagnetic wave, a sensor element for magnetic field, a sensor element for capacitance change or a sensor element for pressure, examples of which include an image pickup element, a radiation sensor element, a photo sensor element, a magnetic sensor element, capacitive sensor element, touch sensor element, or pressure sensor element. In one or a plurality of embodiments, examples of the radiation sensor element include an X-ray sensor element. In one or a plurality of embodiments, the sensor element according to the present disclosure includes a sensor element that is manufactured by using the polyamide solution according to the present disclosure, and/or a sensor element that is manufactured by using the laminated composite material according to the present disclosure, and/or a sensor element that is manufactured by the process for manufacturing an element according to the present disclosure. Further, in one or a plurality of embodiments, forming of the sensor element according to the present disclosure includes forming of a photoelectric conversion element and a driver element.

In one or a plurality of non-limiting embodiments, the “sensor element” produced by the production method according to the present disclosure can be used in an input device. In the present disclosure, in one or a plurality of embodiments, examples of an input device using the “sensor element” include an optical input device, an image pickup input device, a magnetic input device, a capacitive input device and a pressure input device. In one or a plurality of non-limiting embodiments, examples of the input device include a radiation image pickup device, a visible light image pickup device, a magnetic sensor device touch panel, fingerprint authentication panel, light emitting material using piezoelectric device. In one or a plurality of embodiments, examples of the radiation image pickup device include an X-ray pickup device. Further, in one or a plurality of non-limiting embodiments, an input device according to the present disclosure may have a function of an output device such as display function.

[Polyamide Solution]

The polyamide solution used in the production method according to the present disclosure may be a solution of polyamide that includes an aromatic polyamide having repeat units represented by general formulae (I) and (II) below and a solvent, in terms of being used for the sensor element used in an input device:

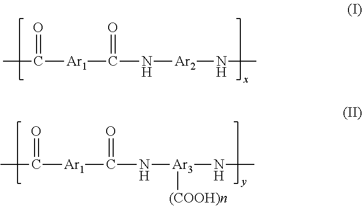

wherein x represents mol % of the constitutional unit of formula (I), y represents mol % of the constitutional unit of formula (II), x is 70 to 100 mol %, y is 0 to 30 mol %, and n is 1 to 4,

wherein in formulae (I) and (II), Ar₁ is selected from the group comprising:

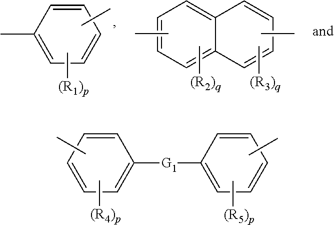

wherein p=4, q=3,

wherein R₁, R₂, R₃, R₄ and R₅ are selected from the group comprising hydrogen, halogen (fluorine, chlorine, bromine, and iodine), an alkyl group, a substituted alkyl group such as halogenated alkyl, a nitro group, a cyano group, a thioalkyl group, an alkoxy group, a substituted alkoxy group such as a halogenated alkoxy group, an aryl group or a substituted aryl group such as a halogenated aryl group, an alkyl ester group and a substituted alkyl ester group such as a halogenated alkyl ester group, and combinations thereof, wherein each R₁ can be different, each R₂ can be different, each R₃ can be different, each R₄ can be different, and each R₅ can be different,

wherein G₁ is selected from the group comprising: a covalent bond (bond); a CH₂ group; a C(CH₃)₂ group; a C(CF₃)₂ group; a C(CX₃)₂ group, wherein X is halogen (fluorine, chlorine, bromine, and iodine); a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group, such as a phenyl group, a biphenyl group, a perfluorobiphenyl group, a 9,9-bisphenylfluorene group, and a substituted 9,9-bisphenylfluorene group, wherein in formula (I), Ar₂ is selected from the group comprising:

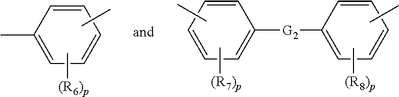

wherein p=4,

wherein R₆, R₇ and R₈ are selected from the group comprising hydrogen, halogen (fluorine, chlorine, bromine, and iodine), an alkyl group, a substituted alkyl group such as a halogenated alkyl group, a nitro group, a cyano group, a thioalkyl group, an alkoxy group, substituted alkoxy such as a halogenated alkoxy group, aryl, substituted aryl such as halogenated aryl, alkyl ester, and substituted alkyl ester such as halogenated alkyl ester, and combinations thereof, wherein each R₆ can be different, each R₇ can be different, and each R₈ can be different,

wherein G₂ is selected from the group comprising: a covalent bond (bond); a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group, such as a phenyl group, a biphenyl group, a perfluorobiphenyl group, a 9,9-bisphenylfluorene group, and a substituted 9,9-bisphenylfluorene group,

wherein in formula (II), Ar₃ is selected from the group comprising:

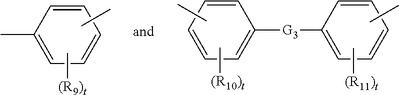

wherein t=0 to 3,

wherein R₉, R₁₀, and R₁₁ are selected from the group comprising hydrogen, halogen (fluorine, chlorine, bromine, and iodine), alkyl, substituted alkyl such as halogenated alkyl, nitro, cyano, thioalkyl, alkoxy, substituted alkoxy such as halogenated alkoxy, aryl, substituted aryl such as halogenated aryl, alkyl ester, and substituted alkyl ester such as halogenated alkyl ester, and combinations thereof, wherein each R₉ can be different, each R₁₀ can be different, and each R₁₁ can be different, and

wherein G₃ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; substituted 9,9-fluorene; and an OZO group, wherein Z is an aryl group or substituted aryl group, such as a phenyl group, a biphenyl group, a perfluorobiphenyl group, a 9,9-bisphenylfluorene group, and substituted 9,9-bisphenylfluorene.

In one or a plurality of embodiments of the present disclosure, formulae (I) and (II) are selected so that the polyamide is soluble in a polar solvent or a mixed solvent containing one or more polar solvents. In one or a plurality of embodiments of the present disclosure, x of the repeat structure (I) is 70.0 to 99.99 mol %, and y of the repeat structure (II) is 30.0 to 0.01 mol %. In one or a plurality of embodiments of the present disclosure, x of the repeat structure (I) is 90.0 to 99.99 mol %, and y of the repeat structure (II) is 10.0 to 0.01 mol %. In one or a plurality of embodiments of the present disclosure, x of the repeat structure (I) is 90.1 to 99.9 mol %, and y of the repeat structure (II) is 9.9 to 0.1 mol %. In one or a plurality of embodiments of the present disclosure, x of the repeat structure (I) is 90.0 to 99.0 mol %, and y of the repeat structure (II) is 10.0 to 1.0 mol %. In one or a plurality of embodiments of the present disclosure, x of the repeat structure (I) is 92.0 to 98.0 mol %, and y of the repeat structure (II) is 8.0 to 2.0 mol %. In one or a plurality of embodiments of the present disclosure, Ar₁, Ar₂, and Ar₃ contain the same or different multiple repeat structures (I) and (II).

[Thermogravimetric Measurement (TG) of Polyamide]

In one or a plurality of embodiments, as to the polyamide solution used in the production method according to the present disclosure, in terms of being used for the sensor element used in an input device, the mass change of a cast film formed on a glass substrate from 300° C. to 400° C. is, for example, 3.0% or less, 2.0% or less, 1.5% or less, or 1.0% or less, the mass change being measured by the thermogravimetric measurement (TG). In one or a plurality of embodiments, the mass change from 300° C. to 400° C. measured by the thermogravimetric measurement (TG) can be measured by a method described in Example.

In the present disclosure, in one or a plurality of embodiments, the “cast film formed on a glass substrate” refers to a film obtained by applying the polyamide solution according to the present disclosure onto a flat glass base, followed by drying and curing as needed. In one or a plurality of embodiments, the cast film refers to a film formed by a film formation method disclosed in Example. In one or a plurality of non-limiting embodiments, the cast film has a thickness of 7-12 μm, 9-12 μm, 9-11 μm, about 10 μm, or 10 μm.

[Glass Transition Temperature of Polyamide]

In one or a plurality of embodiments, as to the polyamide solution used in the production method according to the present disclosure, in terms of being used for the sensor element used in an input device, the cast film formed on a glass substrate has a glass transition temperature of, for example, 550° C. or lower, 530° C. or lower, or 500° C. or lower. In one or a plurality of embodiments, the glass transition temperature can be measured by a method described in Example.

[Refractive Index]

In one or a plurality of embodiments, as to the polyamide solution used in the production method according to the present disclosure, in terms of being used for the sensor element used in an input device, the cast film formed on a glass substrate preferably satisfies a relationship of {(Nx+Ny)/2−Nz}>0.01, where Nx and Ny respectively represent refractive indices in two orthogonal in-plane directions of the film, and Nz represents a refractive index in the thickness direction of the film. By satisfying the relationship, it is possible to suppress reflection of light inside the sensor element and obtain a sensor with excellent accuracy.

[Rigid Structure]

In one or a plurality of embodiments, in terms of being used for the sensor element used in an input device, the polyamide solution used in the production method according to the present disclosure contains a rigid structure (rigid component) in a proportion of preferably 60 mol % or more, and more preferably 95 mol % or more. In the present disclosure, the rigid structure refers to a structure in which the main skeleton of a monomer component (constitutional unit) constituting an aromatic polyamide has linearity.

Therefore, in one or a plurality of embodiments, as to the polyamide solution used in the production method according to the present disclosure, in terms of being used for the sensor element used in an input device, the ratio of the total amount of Ar₁ represented by

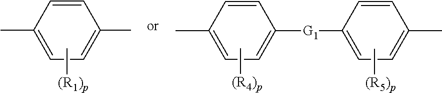

Ar₂ represented by

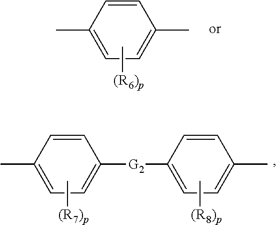

and Ar₃ represented by

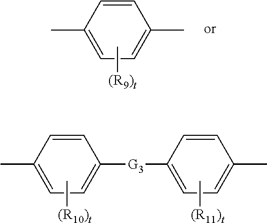

with respect to the total amount of Ar₁, Ar₂, and Ar₃ of general formulae (I) and (II) of the polyamide of the polyamide solution is preferably 60 mol % or more, and more preferably 95 mol % or more. In one or a plurality of embodiments, a specific example of Ar₁ is a structure derived from terephthaloyl dichloride (TPC). In one or a plurality of embodiments, specific examples of Ar₂ and Ar₃ are a structure derived from 4,4′-diamino-2,2′-bistrifluoromethylbenzidine (PFMB) and a structure derived from 4,4′-diaminobiphenyl, respectively.

[Average Molecular Weight]

In one or a plurality of embodiments, the polyamide of the polyamide solution used in the production method according to the present disclosure preferably has a number average molecular weight (Mn) of 0.5×10⁴ or more, 1.0×10⁴ or more, 3.0×10⁴ or more, 5.0×10⁴ or more, 6.0×10⁴ or more, 6.5×10⁴ or more, 7.0×10⁴ or more, 7.5×10⁴ or more, or 8.0×10⁴ or more, in terms of being used for the sensor element used in an input device. Further, the number average molecular weight preferably is 1.0×10⁶ or less, 8.0×10⁵ or less, 6.0×10⁵ or less, or 4.0×10⁵ or less.

In one or a plurality of embodiments, the polyamide of the polyamide solution used in the production method according to the present disclosure preferably has a molecular weight distribution (=Mw/Mn) between a weight average molecular weight (Mw) and a number average molecular weight (Mn) of 8.0 or less, 7.0 or less, 6.0 or less, 5.0 or less, 4.0 or less, 3.0 or less, 2.8 or less, 2.6 or less, or 2.4 or less, in terms of being used for the sensor element used in an input device. Further, the molecular weight distribution preferably is 2.0 or more. In the present specification, Gel Permeation Chromatography (GPC) is used to measure the number average molecular weight (Mn) and the weight average molecular weight (Mw) of the polyamide.

In one or a plurality of embodiments, in terms of being used for the sensor element used in an input device, the polyamide solution used in the production method according to the present disclosure may be a polyamide solution in which low molecular components have been reduced. In one or a plurality of embodiments, from the same viewpoint, the polyamide solution may be a polyamide solution whose low molecular components having a molecular weight of 1000 or less are undetectable, or detectable only in a very small amount by Gel Permeation Chromatography (GPC).

In one or a plurality of embodiments, in terms of being used for the sensor element used in an input device, the polyamide solution used in the production method according to the present disclosure may be a polyamide solution that has undergone a precipitation step after synthesis of polyamide. The precipitation can be performed by any general method. In one or a plurality of embodiments, by adding the polyamide solution to methanol, ethanol, isopropyl alcohol or the like, the polyamide is precipitated, cleaned, and re-dissolved in the solvent, for example.

In one or a plurality of embodiments, in terms of being used for the sensor element used in an input device, the polyamide of the polyamide solution used in the production method according to the present disclosure may be a polyamide that is end-capped at least at one end. The terminal of the polyamide can be end-capped by the reaction of a polymerized polyamide with benzoyl chloride when the terminal of the polyamide is —NH₂, or reaction of a polymerized polyamide with aniline when the terminal of the polyamide is —COOH. However, the method of end-capping is not limited to this method.

[Total Light Transmittance]

In one or a plurality of embodiments, as to the polyamide solution used in the production method according to the present disclosure, in terms of being used for the sensor element used in an input device, the cast film formed by casting the polyamide solution on a glass plate has, in one or a plurality of embodiments, a total light transmittance at 400 nm of 70% or more, 75% or more, or 80% or more in terms of allowing the laminated composite material to be used suitably in the sensor element used in an input device.

[Inorganic Filler]

In one or a plurality of embodiments, in terms of being used for the sensor element used in an input device, the polyamide solution used in the production method according to the present disclosure may contain inorganic filler. In one or a plurality of embodiments, the inorganic filler is in the form of a fiber or particle. The material of the inorganic filler contained in the polyamide solution according to the present disclosure is not particularly limited as long as it is an inorganic material. In one or a plurality of embodiments, the inorganic filler may be a metal oxide such as silica, alumina, or titanium oxide, mineral such as mica, glass or a mixture thereof. Examples of the glass include E glass, C glass, A glass, S glass, D glass, NE glass, T glass, low dielectric constant glass and high dielectric constant glass.

When the inorganic filler is in the form of a fiber, the fiber has an average fiber diameter of 1 to 1000 nm in terms of reducing both the coefficient of thermal expansion of the film and retardation in film thickness direction as well as improving the transparency of the film. Here, the fiber may be composed of monofilaments that are arranged sufficiently apart from each other without being aligned such that a liquid precursor of a matrix resin can enter the space between the monofilaments. In this case, the average fiber diameter is the average diameter of the monofilaments. Further, the fiber may be a bundle of multiple monofilaments forming threads. In this case, the average fiber diameter is defined as the average diameter of the threads. Specifically, the average fiber diameter is measured by a method in Example. Further, the smaller the average fiber diameter of the fiber and the closer the refractive index of the polyamide resin contained in the polyamide solution and the refractive index of the inorganic filler, the more preferable it is in terms of improving the transparency of the film. For example, when the difference in refractive index between the material of the fiber and the polyamide at 589 nm is 0.01 or less, highly transparent films can be formed regardless of the fiber diameter. Examples of ways to determine the average fiber diameter include observation under an electron microscope, and the like.

When the inorganic filler is in the form of particles, the average particle diameter of the particles is 1 to 1000 nm in terms of reducing both the coefficient of thermal expansion of the film and retardation in film thickness direction as well as improving the transparency of the film. Here, the average particle diameter of the particles refers to an average diameter of projected equivalent circles, and more specifically it is measured by a method in Example. The shape of the particles is not particularly limited. In one or a plurality of embodiments, the particles may have a spherical or true-spherical shape, a rod shape, a plate shape, or a bound shape of these in terms of reducing both the coefficient of thermal expansion of the film and retardation in film thickness direction. Further, the smaller the average particle diameter of the particles and the closer the refractive index of the polyamide resin contained in the polyamide solution and the refractive index of the inorganic filler, the more preferable it is in terms of improving the transparency of the film. For example, when the difference in refractive index between the material of the particles and the polyamide at 589 nm is 0.01 or less, highly transparent films can be formed regardless of the particle diameter. Further, the average particle diameter may be measured by, for example, using a particle diameter distribution meter.

In one or a plurality of embodiments, the inorganic filler accounts for 1 vol % to 30 vol % of the solid content of the polyamide solution. Further, the polyamide accounts for 50 vol % to 99 vol %, 60 to 98 vol %, or 70 to 97 vol % of the solid content of the polyamide solution. The term “solid content” as used herein refers to the components of the polyamide solution other than the solvent. The solid content in terms of volume, the amount of the inorganic filler in terms of volume, and/or the amount of the polyamide in terms of volume can be calculated from the amount of each component introduced to prepare the polyamide solution or can also be calculated by removing the solvent from the polyamide solution.

[Solid Content]

In one or a plurality of embodiments, in terms of handleability in each step, the solid content of the polyamide solution used in the production method according to the present disclosure is, for example, 1 vol % or more, 2 vol % or more, or 3 vol % or more. From the same viewpoint, the solid content is, for example, 40 vol % or less, 30 vol % or less, or 20 vol % or less.

[Solvent]

In one or a plurality of embodiments of the present disclosure, in terms of enhancing solubility of the polyamide to the solvent, the solvent is a polar solvent or a mixed solvent containing one or more polar solvents. In one or a plurality of embodiments, in terms of enhancing solubility of the polyamide to the solvent and enhancing the adhesion between the polyamide film and the base, the solvent is methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc), N-methyl-2-pyrrolidone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-butoxy-N,N-dimethylpropanamide, 1-ethyl-2-pyrrolidone, N,N-dimethylpropionamide, N,N-dimethylbutyramide, N,N-diethylacetamide, N,N-diethylpropionamide, 1-methyl-2-piperidinone, propylene carbonate, a combination thereof, or a mixed solvent containing at least one of the solvents.

[Other Components]

In one or a plurality of embodiments, in terms of being used for the sensor element used in an input device, the polyamide solution used in the production method according to the present disclosure may contain, as needed, a silane coupling agent, an small amount of an antioxidant, an ultraviolet absorber, a dye, a filler such as other inorganic filler and the like.

[Production Method of Polyamide Solution]

In one or a plurality of embodiments, in terms of being used for the sensor element used in an input device, the polyamide solution used in the production method according to the present disclosure is, for example, a polyamide solution that is obtained or obtainable by a production method including the following steps.

However, the polyamide solution according to the present disclosure is not limited to the polyamide solution produced by the following production method.

(a) dissolving an aromatic diamine in a solvent;

(b) adding an aromatic diacid dichloride into the solvent to react the aromatic diamine with the aromatic diacid dichloride, thereby generating a hydrochloric acid and a polyamide solution;

(c) removing using a trapping reagent the hydrochloric acid liberated by the reaction; and

(d) adding an inorganic filler, as needed.

In one or a plurality of embodiments, in terms of being used for the sensor element used in an input device, examples of the aromatic diamine used in production of the polyamide solution include the following:
4,4′-Diamino-2,2′-bistrifluoromethylbenzidine (PFMB);

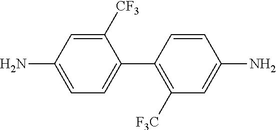 [SMILES: Nc1ccc(-c2ccc(N)cc2C(F)(F)F)c(C(F)(F)F)c1]

9,9-Bis(4-aminophenyl)fluorene (FDA);

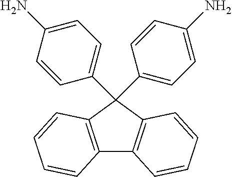 [SMILES: Nc1ccc(C2(c3ccc(N)cc3)c3ccccc3-c3ccccc32)cc1]

9,9-Bis(3-fluoro-4-aminophenyl)fluorene (FFDA);

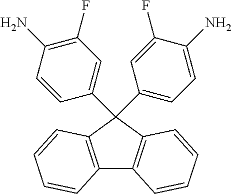 [SMILES: Nc1ccc(C2(c3ccc(N)c(F)c3)c3ccccc3-c3ccccc32)cc1F]

4,4′-diaminodiphenyl sulfone (DDS)

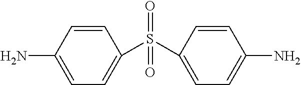 [SMILES: Nc1ccc(S(=O)(=O)c2ccc(N)cc2)cc1]

DDS may be 3,3′-type or 2,2′-type as well as 4,4′-type.
4,4′-Diaminodiphenic acid (DADP);

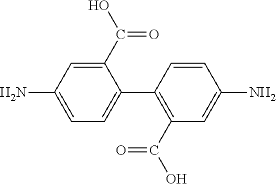 [SMILES: Nc1ccc(-c2ccc(N)cc2C(=O)O)c(C(=O)O)c1]

3,5-Diaminobenzoic acid (DAB);

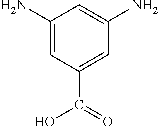 [SMILES: Nc1cc(N)cc(C(=O)O)c1]

4,4′-Diamino-2,2′-bistrifluoromethoxylbenzidine (PFMOB);

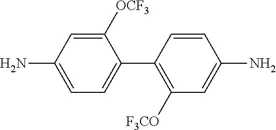 [SMILES: Nc1ccc(-c2ccc(N)cc2OC(F)(F)F)c(OC(F)(F)F)c1]

4,4′-Diamino-2,2′-bistrifluoromethyldiphenyl ether (6FODA);

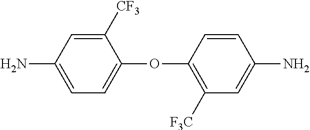 [SMILES: Nc1ccc(Oc2ccc(N)cc2C(F)(F)F)c(C(F)(F)F)c1]

Bis(4-amino-2-trifluoromethylphenyloxyl)benzene (6FOQDA); and

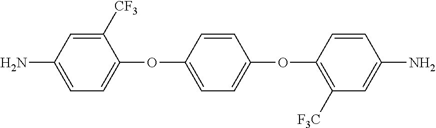 [SMILES: Nc1ccc(Oc2ccc(Oc3ccc(N)cc3C(F)(F)F)cc2)c(C(F)(F)F)c1]

Bis(4-amino-2-trifluoromethylphenyloxyl)biphenyl (6FOBDA)

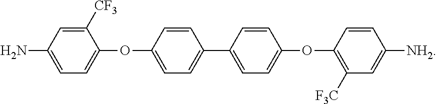 [SMILES: Nc1ccc(Oc2ccc(-c3ccc(Oc4ccc(N)cc4C(F)(F)F)cc3)cc2)c(C(F)(F)F)c1]

In one or a plurality of embodiments, in terms of being used for the sensor element used in an input device, examples of the aromatic diacid dichloride used in production of the polyamide solution include the following aromatic dicarboxylic acid dichloride:
Terephthaloyl dichloride (TPC);

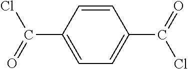 [SMILES: O=C(Cl)c1ccc(C(=O)Cl)cc1]

Isophthaloyl dichloride (IPC);

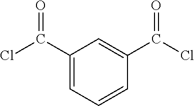 [SMILES: O=C(Cl)c1cccc(C(=O)Cl)c1]

2,6-Naphthaloyl dichloride (NDC); and

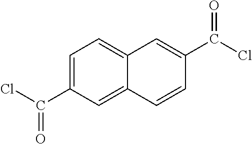 [SMILES: O=C(Cl)c1ccc2cc(C(=O)Cl)ccc2c1]

4,4′-Biphenyldicarbonyl dichloride (BPDC)

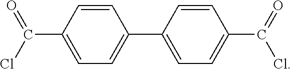 [SMILES: O=C(Cl)c1ccc(-c2ccc(C(=O)Cl)cc2)cc1]

An example of the chloric trapping reagent used in production of the polyamide solution is propylene oxide (PrO). In one or a plurality of embodiments, the trapping reagent is added to the mixture before or during the reacting step (b). Adding the reagent before or during the reaction step (b) can reduce degree of viscosity and generation of lumps in the mixture after the reaction step (b), thereby improving the productivity of the polyamide solution. These effects are significant especially when the reagent is an organic reagent such as propylene oxide.

In one or a plurality of embodiments of the present disclosure, in terms of enhancing heat resistance property of the polyamide film, the production method of the polyamide solution further includes a step of end-capping one or both of terminal —COOH group and terminal —NH₂ group of the polyamide. The terminal of the polyamide can be end-capped by the reaction of a polymerized polyamide with benzoyl chloride when the terminal of the polyamide is —NH₂, or reaction of a polymerized polyamide with aniline when the terminal of the polyamide is —COOH. However, the method of end-capping is not limited to this method.

In one or a plurality of embodiments of the present disclosure, in terms of being used for the sensor element used in an input device, the polyamide is first isolated from the polyamide solution by precipitation and re-dissolution in a solvent. The precipitation can be performed by any general method. In one or a plurality of embodiments, by adding the polyamide solution to methanol, ethanol, isopropyl alcohol or the like, the polyamide is precipitated, cleaned, and dissolved in the solvent, for example.

In one or a plurality of embodiments of the present disclosure, in terms of being used for the sensor element used in an input device, the polyamide solution used in the production method according to the present disclosure is produced in the absence of inorganic salts.

[Laminated Composite Material]

The term “laminated composite material” as used herein refers to a material in which a glass plate and a polyamide resin layer are laminated. In one or a plurality of non-limiting embodiments, a glass plate and a polyamide resin layer being laminated means that the glass plate and the polyamide resin layer are laminated directly. Further, in one or a plurality of non-limiting embodiments, it means that the glass plate and the polyamide resin layer are laminated through one or more layers. In the present disclosure, the polyamide resin layer in the laminated composite material can be produced by the polyamide solution used in the production method according to the present disclosure.

[Warpage Deformation]

The term “warpage deformation of the laminated composite material” as used herein refers to a difference between a maximum value and a minimum value in height of the laminated composite material, which is measured by a laser displacement sensor. In one or a plurality of embodiments, the warpage deformation is measured by a method described in Example. In one or a plurality of embodiments, as to the polyamide solution used in the production method according to the present disclosure, in terms of being used for the sensor element used in an input device, the warpage deformation of the laminated composite material is 500 μm or less, or 250 μm or less, for example. Further, from the same viewpoint, in one or a plurality of embodiments, it is −500 μm or more, or −250 μm or more, for example. Incidentally, when the value of the warpage deformation of the laminated composite material is positive, the periphery of the laminated composite material is higher than the central portion. When the value of the warpage deformation of the laminated composite material is negative, the periphery of the laminated composite material is lower than the central portion.

In one or a plurality of non-limiting embodiments, the laminated composite material can be used as a laminated composite material obtained in the step b of the production method of the sensor element typified by FIG. 1. In one or a plurality of embodiments, the laminated composite material may include an additional organic resin layer and/or inorganic layer in addition to the polyamide resin layer. In one or a plurality of non-limiting embodiments, the additional organic resin layer may be a flattened coating layer. Further, in one or a plurality of non-limiting embodiments, the inorganic layer may be a gas barrier layer capable of suppressing permeation of water and oxygen, and a buffer coat layer capable of suppressing migration of ions to a TFT element.

In one or a plurality of embodiments, the polyamide resin layer of the laminated composite material has a thickness of, for example, 500 μm or less, 200 μm or less, or 100 μm or less. Further, in one or a plurality of non-limiting embodiments, the polyamide resin layer has a thickness of, for example, 1 μm or more, 2 μm or more, or 3 μm or more.

In one or a plurality of embodiments, the material of the glass plate of the laminated composite material may be soda-lime glass, none-alkali glass, or the like. In one or a plurality of embodiments, the glass plate has a thickness of, for example, 0.3 mm or more, 0.4 mm or more, or 0.5 mm or more. Further, in one or a plurality of embodiments, the glass plate has a thickness of, for example, 3 mm or less, or 1 mm or less.

[Production Method of Sensor Element]

The production method according to the present disclosure includes the following steps (A) and (B):

(A) applying the aforementioned polyamide solution onto a base to form a polyamide film on the base; and

(B) forming a sensor element on the surface of the polyamide film.

As the base, for example, at lease the surface is composed of glass or silicon wafer. In one or a plurality of embodiments, examples of the glass include soda-lime glass, none-alkali glass, and the like. In one or a plurality of embodiments, the base has a thickness of, for example, 0.3 mm or more, 0.4 mm or more, or 0.5 mm or more. Further, in one or a plurality of embodiments, the glass plate has a thickness of, for example, 3 mm or less, or 1 mm or less.

In the step (A) of the production method according to the present disclosure, the laminated composite material can be formed. In one or a plurality of embodiments, the step (A) of the production method according to the present disclosure includes the following steps (i) and (ii):

(i) applying the aforementioned polyamide solution onto a base (see the step a in FIG. 1); and

(ii) after the step (i), heating the applied polyamide solution to form a polyamide film (see the step b in FIG. 1).

In one or a plurality of embodiments, the application in the step (i) can be performed by various liquid phase film formation methods such as a die coating method, an ink jet method, a spin coating method, a bar coating method, a roll coating method, a wire bar coating method, and a dip coating method.

In one or a plurality of embodiments, in terms of suppressing curvature deformation (warpage) of the laminated composite material and/or enhancing dimensional stability, the heating of the step (ii) is performed under the temperature ranging from approximately +40° C. of the boiling point of the solvent of the aforementioned polyamide solution to approximately +100° C. of the boiling point of the solvent, preferably from approximately +60° C. of the boiling point of the solvent to approximately +80° C. of the boiling point of the solvent, more preferably approximately +70° C. of the boiling point of the solvent. In one or a plurality of embodiments, in terms of suppressing curvature deformation (warpage) of the laminated composite material and/or enhancing dimensional stability, the temperature of the heating of the step (ii) is between approximately 200° C. and approximately 250° C. In one or a plurality of embodiments, in terms of suppressing curvature deformation (warpage) of the laminated composite material and/or enhancing dimensional stability, the time of the heating of the step (ii) is more than approximately 1 minute and less than approximately 30 minutes.

The production method according to the present disclosure may include, following the step (ii), a curing step (iii) in which the polyamide film is cured. The curing temperature depends upon the capability of a heating device but is 220° C. to 420° C., 280° C. to 400° C., 330° C. to 370° C., 340° C. or higher, or 340 to 370° C. in one or a plurality of embodiments. Further, in one or a plurality of embodiments, the curing time is 5 to 300 minutes or 30 to 240 minutes.

The formation of the sensor element in the step (B) of the production method according to the present disclosure is not particularly limited, and they can be formed appropriately depending on the sensor element used for the production of conventional or future elements.

In one or a plurality of embodiments, the production method according to the present disclosure includes, as step (C), a step of de-bonding a formed sensor element from the glass plate after the step (B). In the de-bonding step (C), the formed sensor element is de-bonded from the base. To implement the de-bonding step, for example, the sensor element may be physically stripped from the base. At that time, the base may be provided with a de-bonding layer, or a wire may be inserted between the base and the sensor element to remove the sensor element. Further, examples of other methods include the following: forming a de-bonding layer on the base except at ends, and cutting, after the preparation of the element, the inner part from the ends to remove the element from the base; providing a layer of silicon or the like between the base and the element, and irradiating the silicon layer with a laser to strip the element; applying heat to the base to separate the base and the element from each other; and removing the base using a solvent. These methods may be used alone or any of these methods may be used in combination of two or more. In one or a plurality of embodiments, the strength of adhesion between the polyamide film and the base can be controlled by a silane coupling agent, so that the sensor element can be physically stripped without using the above-described complicated steps.

[Sensor Element]

In one or a plurality of embodiments, the present disclosure relates to a sensor element produced by the production method according to the present disclosure. The sensor element includes a polyamide film formed from a polyamide solution used in the production method of the present disclosure. The sensor element produced by the production method of the present disclosure can be used in production of various input devices.

[Input Device]

Therefore, the present disclosure, in the aspect, relates to input devices using the sensor element produced by the production method according to the present disclosure, and further relates to the production method of the input devices. Although not limited to these, examples of the input devices include above-mentioned input devices.

[Non-Limiting Embodiment of Sensor Element]

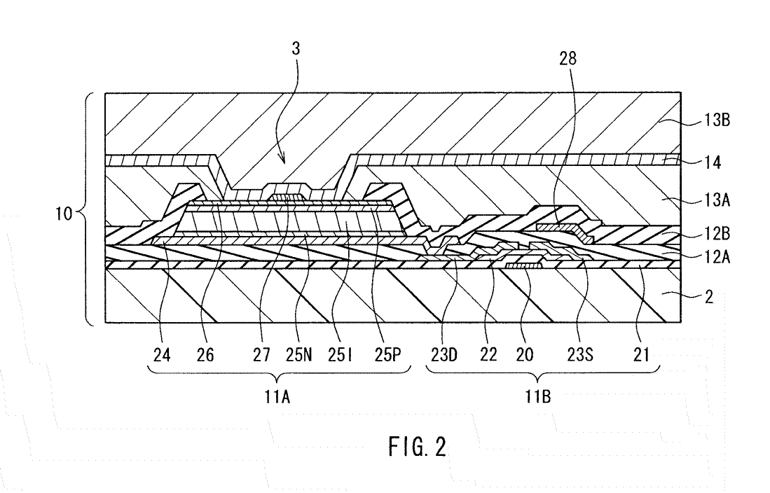

Hereinafter, an embodiment of the sensor element that can be produced by the production method according to the present disclosure will be described using FIG. 2.

FIG. 2 is a schematic cross-sectional view showing a sensor element 10 according to one embodiment. The sensor element 10 has a plurality of pixels. In the sensor element 10, on the surface of a substrate 2, a pixel circuit is formed that includes a plurality of photodiodes 11A (photoelectric conversion elements) and thin film transistors (TFTs) 11B serving as driving elements of the photodiodes 11A. The substrate 2 is a polyamide film, which is formed on the base (not shown) through the step (A) of the production method according to the present disclosure. Then, in the step (B) of the production method according to the present disclosure, the photodiodes 11A (photoelectric conversion elements) and the thin film transistors 11B serving as driving elements of the photodiodes 11A are formed.

A gate insulating film 21 is formed on the substrate 2, and composed of a monolayer film made of one of a silicon oxide (SiO₂) film, a silicon oxynitride (SiON) film and a silicon nitride (SiN) film, or a laminated film made of two or more of these, for example. A first interlayer insulating film 12A is provided on the gate insulating film 21, and made of an insulating film such as a silicon oxide film and a silicon nitride film, for example. The first interlayer insulating film 12A also serves as a protection film (passivation film) that covers the thin film transistor 11B described below.

(Photodiode 11A)

The photodiode 11A is arranged in a selected area on the substrate 2 through the gate insulating film 21 and the first interlayer insulating film 12A. Specifically, the photodiode 11A is formed by laminating a lower electrode 24, an n-type semiconductor layer 25N, an i-type semiconductor layer 251, a p-type semiconductor layer 25P, and an upper electrode 26 in this order on the first interlayer insulating film 12A. The upper electrode 26 is, for example, an electrode that supplies a reference potential (bias potential) for photoelectric conversion to the aforementioned photoelectric conversion layer, and connected to a wiring layer 27, which is a power supply source wiring for supplying the reference potential. The upper electrode 26 is composed of a transparent conductive film such as ITO (Indium Tin Oxide), for example.

(Thin Film Transistor 11B)

The thin film transistor 11B is composed of a field effect transistor (FET), for example. In the thin film transistor 11B, a gate electrode 20 made of titanium (Ti), Al, Mo, tungsten (W), chromium (Cr), or the like is formed on the substrate 2, and the aforementioned gate insulating film 21 is formed on the gate electrode 20. Further, a semiconductor layer 22 having a channel region is formed on the gate insulating film 21. A source electrode 23S and a drain electrode 23D are formed on the semiconductor layer 22. Specifically, in this case, the drain electrode 23D is connected to the lower electrode 24 in the photodiode 11A, and the source electrode 23S is connected to a relay electrode 28.

Further, in the sensor element 10, a second interlayer insulating film 12B, a first flattened film 13A, a protection film 14 and a second flattened film 13B are arranged in this order on the upper layers of the photodiode 11A and the thin film transistor 11B. Further, an opening 3 is formed in the first flattened film 13A in the vicinity of the formation region of the photodiode 11A.

It is possible to manufacture a radiation image pickup device by forming a wavelength conversion member on the sensor element 10, for example.

Regarding the above-mentioned embodiments, the present disclosure further discloses compositions, manufacturing processes and applications below.

<1> A method for producing a sensor element, comprising the following steps (A) and (B):

(A) applying a polyamide solution onto a base to form a polyamide film on the base; and

(B) forming a sensor element on the surface of the polyamide film, wherein the base or the surface of the base is composed of glass or silicon wafer, wherein a polyamide of the polyamide solution has a constitutional unit represented by the following general formulae (I) and (II):

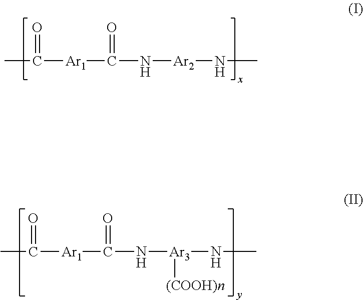

wherein x represents mol % of the constitutional unit of formula (I), y represents mol % of the constitutional unit of formula (II), x is 70 to 100 mol %, y is 0 to 30 mol %, and n is 1 to 4,

wherein Ar₁ is selected from the group comprising:

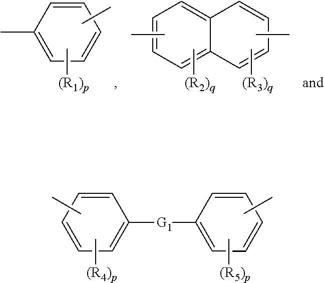

wherein in the formula above, p=4, q=3,

wherein R₁, R₂, R₃, R₄ and R₅ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,

wherein G₁ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,

wherein Ar₂ is selected from the group comprising:

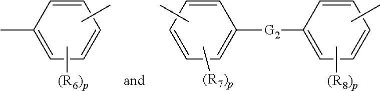

wherein in the formula above, p=4,

wherein R₆, R₇ and R₈ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,

wherein G₂ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,

wherein Ar₃ is selected from the group comprising:

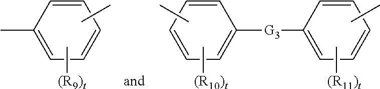

wherein in the formula above, t=0 to 3,

wherein R₉, R₁₀ and R₁₁ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof, and

wherein G₃ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group.

<2> The production method according to <1>, wherein a cast film formed by applying the polyamide solution onto a glass base satisfies a relationship of {(Nx+N_{y})/2−Nz}>0.01, where Nx and Ny respectively represent refractive indices in two orthogonal in-plane directions of the film, and Nz represents a refractive index in the thickness direction of the film.

<3> The production method according to <1> or <2>,

wherein the mass change, from 300° C. to 400° C., of a cast film formed by applying the polyamide solution onto a glass base is 3.0% or less, the mass change being measured by thermogravimetric measurement (TG), and
a polyamide resin has a glass transition temperature of 300° C. or higher.

<4> The production method according to any one of <1> to <3>,

wherein a ratio of a total amount of Ar₁ represented by

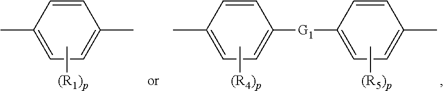

Ar₂ represented by

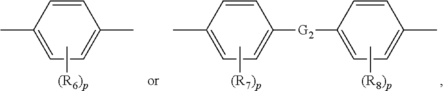

and Ar₃ represented by

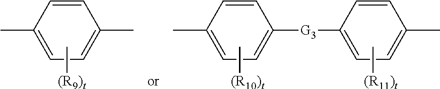

with respect to a total amount of Ar₁, Ar₂, and Ar₃ of general formulae (I) and (II) of the polyamide of the polyamide solution is 60 mol % or more.

<5> The production method according to any one of <1> to <4>, wherein a content of a diamine monomer component containing a carboxyl group is 30 mol % or less based on a total amount of monomers used in synthesis of the polyamide.

<6> The production method according to any one of <1> to <5>, wherein the polyamide of the polyamide solution is end-capped at least at one end.

<7> The production method according to any one of <1> to <6>, wherein the polyamide solution further contains an inorganic filler.

<8> The production method according to any one of <1> to <7>, wherein the sensor element is a sensor element used in an optical input device or an imaging input device.

<9> The production method according to any one of c<1> to <8>, wherein the sensor element is an image pickup element, a radiation sensor element, a photo sensor element, a magnetic sensor element, a capacitive sensor element, a touch sensor element, or a pressure sensor element.

<10> The production method according to any one of <1> to <9>, further comprising the step of de-bonding a formed sensor element from the base.

<11> A sensor element for an input device comprises a polyamide film produced by using the production method according to any one of <1> to <10> and formed from the polyamide solution.

### EXAMPLE

### Example 1

The present example describes a general procedure for preparing a solution A1 that contains 5 mass % of a copolymer of TPC, PFMD, FDA, and DAB (molar ratio: 100%/80%/15%/5%) in DMAc. The production method includes a step of precipitating a synthesized polymer after a synthesis step. To a 250 ml three necked round bottom flask equipped with a mechanical stirrer, a nitrogen inlet and a nitrogen outlet, PFMB (0.0080 mol), FDA (0.0015 mol), DAB (0.0005 mol) and DMAc (30 ml) are added at room temperature in the presence of nitrogen. After complete dissolution of the PFMB, FDA and DAB, PrO (1.4 g, 0.024 mol) is added to the solution. The solution is cooled to 0° C. Under stirring, TPC (0.01 mol) is added to the solution, and the flask wall is washed with DMAc (1.5 ml). After two hours, benzoyl chloride (0.032 g, 0.23 mmol) is added to the solution and stirred for another two hours. This solution is added to 500 ml of methanol and stirred. The polymer precipitated in methanol is added to another 150 ml of methanol and washed for 10 minutes two times. Thereafter, the polymer is added in 150 ml of water and washed for 10 minutes two times, followed by dehydration and drying of the polymer. The dried polymer is dissolved in DMAc (60 ml) to obtain the solution A1.

[Preparation of Laminated Composite Material]

The polymer solution A1 is spin-coated on a glass plate (EAGLE XG, Corning Inc., U.S.A., 370 mm×470 mm, thickness 0.5 mm). After drying at 60° C. for 30 minutes on the glass plate, the dried solution 1 is heated from 60° C. to 350° C. under vacuum or inert atmosphere, and cured while keeping the temperature at 350° C. for 30 minutes. Thus, a laminated composite material A2 in which a polyamide film having a thickness of about 10 μm is laminated on the glass plate is obtained.

[Preparation of Sensor Element]

A sensor element is obtained by forming a photoelectric conversion element and a driving element thereof on the produced laminated composite material A2 and de-bonding the resultant from the glass plate.

### Example 2

The present example describes a general procedure for preparing a solution B1 that contains 5 mass % of a copolymer of TPC, PFMD, and FDA (molar ratio: 10%/85%/15%) in DMAc. The production method includes a step of precipitating a synthesized polymer after a synthesis step. To a 250 ml three necked round bottom flask equipped with a mechanical stirrer, a nitrogen inlet and a nitrogen outlet, PFMB (0.0085 mol), FDA (0.0015 mol), and DMAc (30 ml) are added at room temperature in the presence of nitrogen. After complete dissolution of the PFMB, and FDA, PrO (1.4 g, 0.024 mol) is added to the solution. The solution is cooled to 0° C. Under stirring, TPC (0.01 mol) is added to the solution, and the flask wall is washed with DMAc (1.5 ml). After two hours, benzoyl chloride (0.032 g, 0.23 mmol) is added to the solution and stirred for another two hours. This solution is added to 500 ml of methanol and stirred. The polymer precipitated in methanol is added to another 150 ml of methanol and washed for 10 minutes two times. Thereafter, the polymer is added in 150 ml of water and washed for 10 minutes two times, followed by dehydration and drying of the polymer. The dried polymer is dissolved in DMAc (60 ml) to obtain the solution B1.

[Preparation of Laminated Composite Material]

The polymer solution B1. is spin-coated on a glass plate (EAGLE XG, Corning Inc., U.S.A., 370 mm×470 mm, thickness 0.5 mm). After drying at 60° C. for 30 minutes on the glass plate, the dried solution 1 is heated from 60° C. to 350° C. under vacuum or inert atmosphere, and cured while keeping the temperature at 350° C. for 30 minutes. Thus, a laminated composite material B2 in which a polyamide film having a thickness of about 10 μm is laminated on the glass plate is obtained.

[Preparation of Sensor Element]

A sensor element is obtained by forming a photoelectric conversion element and a driving element thereof on the produced laminated composite material B2 and de-bonding the resultant from the glass plate.

The embodiments have been described, hereinabove. It will be apparent to those skilled in the art that the above methods and apparatuses may incorporate changes and modifications without departing from the general scope of this disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of this disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

What is claimed is:

1. A method for producing a sensor element, comprising:
applying a polyamide solution onto a base to form a polyamide film on the base; and
forming a sensor element on the surface of the polyamide film,
wherein the base or the surface of the base is composed of glass or silicon wafer,
wherein a polyamide of the polyamide solution has a constitutional unit represented by formulae (I) and (II): 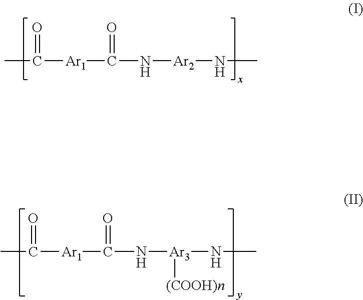
wherein x represents mol % of the constitutional unit of formula (I), y represents mol % of the constitutional unit of formula (II), x is 70 to 100 mol %, y is 0 to 30 mol %, and n is 1 to 4,
wherein Ar₁ is selected from the group comprising: 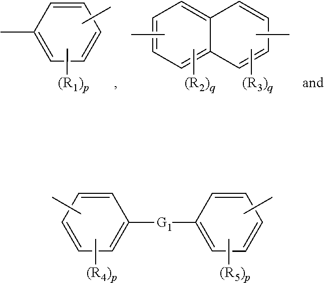
wherein in the formula above, p=4, q=3,
wherein R₁, R₂, R₃, R₄ and R₅ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,
wherein G₁ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,
wherein Ar₂ is selected from the group comprising: 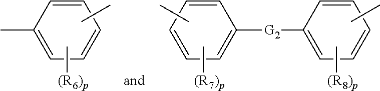
wherein in the formula above, p=4,
wherein R₆, R₇ and R₈ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof,
wherein G₂ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group,
wherein Ar₃ is selected from the group comprising: 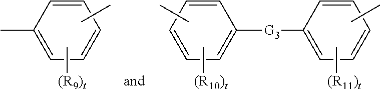
wherein in the formula above, t=0 to 3,
wherein R₉, R₁₀ and R₁₁ are selected from the group comprising hydrogen, halogen, an alkyl group, a substituted alkyl group, a nitro group, a cyano group, a thioalkyl group, an alkoxy group, a substituted alkoxy group, an aryl group, a substituted aryl group, an alkyl ester group, a substituted alkyl ester group, and combinations thereof, and
wherein G₃ is selected from the group comprising: a covalent bond; a CH₂ group; a C(CH₃)₂ group; a C(CF₃)₂ group; a C(CX₃)₂ group, wherein X is halogen; a CO group; an O atom; an S atom; an SO₂ group; an Si(CH₃)₂ group; a 9,9-fluorene group; a substituted 9,9-fluorene group; and an OZO group, wherein Z is an aryl group or substituted aryl group.

2. The production method according to claim 1, wherein a cast film formed by applying the polyamide solution onto a glass base satisfies a relationship of {(Nx+N_{y})/2−Nz}>0.01, where Nx and Ny respectively represent refractive indices in two orthogonal in-plane directions of the film, and Nz represents a refractive index in the thickness direction of the film.

3. The production method according to claim 1,
wherein the mass change, from 300° C. to 400° C., of a cast film formed by applying the polyamide solution onto a glass base is 3.0% or less, the mass change being measured by thermogravimetric measurement (TG), and
a polyamide resin has a glass transition temperature of 300° C. or higher.

4. The production method according to claim 1,
wherein a ratio of a total amount of Ar₁ represented by 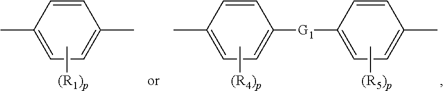
Ar₂ represented by 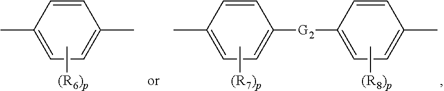
and Ar₃ represented by 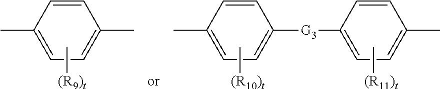
with respect to a total amount of Ar₁, Ar₂, and Ar₃ of general formulae (I) and (II) of the polyamide of the polyamide solution is 60 mol % or more.

5. The production method according to claim 1, wherein a content of a diamine monomer component containing a carboxyl group is 30 mol % or less based on a total amount of monomers used in synthesis of the polyamide.

6. The production method according to claim 1, wherein the polyamide of the polyamide solution is end-capped at least at one end.

7. The production method according to claim 1, wherein the polyamide solution further contains an inorganic filler.

8. The production method according to claim 1, wherein the sensor element is a sensor element used in an optical input device or an imaging input device.

9. The production method according to claim 1, wherein the sensor element is an image pickup element, a radiation sensor element, a photo sensor element, a magnetic sensor element, a capacitive sensor element, a touch sensor element, or a pressure sensor element.

10. The production method according to claim 1, further comprising de-bonding a formed sensor element from the base.

11. A sensor element for an input device comprises a polyamide film produced by the production method according to claim 1 and formed from the polyamide solution.

12. The production method according to claim 2, further comprising de-bonding a formed sensor element from the base.

13. A sensor element for an input device comprises a polyamide film produced by the production method according to claim 2 and formed from the polyamide solution.

14. The production method according to claim 3, further comprising de-bonding a formed sensor element from the base.

15. A sensor element for an input device comprises a polyamide film produced by the production method according to claim 3 and formed from the polyamide solution.

16. The production method according to claim 4, further comprising de-bonding a formed sensor element from the base.

17. A sensor element for an input device comprises a polyamide film produced by the production method according to claim 4 and formed from the polyamide solution.

18. The production method according to claim 5, further comprising de-bonding a formed sensor element from the base.

19. A sensor element for an input device comprises a polyamide film produced by the production method according to claim 5 and formed from the polyamide solution.

20. The production method according to claim 6, further comprising de-bonding a formed sensor element from the base.
